(19) United States
(12) Patent Application Publication
(10) Pub. No.: US 2015/0276404 A1
(43) Pub. Date: Oct. 1, 2015

(54) PHYSICAL QUANTITY DETECTION CIRCUIT, PHYSICAL QUANTITY DETECTING DEVICE, ELECTRONIC APPARATUS, AND MOVING OBJECT

(71) Applicant: Seiko Epson Corporation, Tokyo (JP)

(72) Inventors: Ryuta NISHIZAWA, Matsumoto (JP); Keiji NAKAGAWA, Minowa (JP)

(21) Appl. No.: 14/666,679

(22) Filed: Mar. 24, 2015

(30) Foreign Application Priority Data
Mar. 25, 2014 (JP) 2014-061547

(51) Int. Cl. G01C 19/5642

(52) U.S. Cl. CPC G01C 19/5642

(57) ABSTRACT

A physical quantity detection circuit includes a filter circuit, and a synchronous detection circuit that is provided at a downstream of the filter circuit and detects a signal in response to a physical quantity contained in an output signal of a vibrating element based on a drive signal for driving the vibrating element. The filter circuit has a cutoff frequency between a resonance frequency in a drive mode and a resonance frequency in a detection mode of the vibrating element and contains the resonance frequency in the drive mode in a passband.

### BACKGROUND

1. Technical Field

The present invention relates to a physical quantity detection circuit, a physical quantity detecting device, an electronic apparatus, and a moving object.

2. Related Art

Physical quantity detecting devices that detect physical quantities such as angular velocities and acceleration using vibrating elements including crystal vibrators (piezoelectric vibrators) and MEMS (Micro Electro Mechanical Systems) vibrators are known.

For example, as angular velocity detecting devices for detecting rotation angular velocities of rotation systems, vibration gyro sensors using piezoelectric elements such as crystal vibrators are incorporated in various electronic apparatuses and used for car navigation, hand shake detection at imaging, etc.

The vibration gyro sensor is proposed in Patent Document 1 (JP-A-2010-256332), for example.

However, in the physical quantity detecting device of related art like the vibration gyro sensor disclosed in Patent Document 1, a rotational vibration is generated about the detection axis of the vibrating element due to resonance of the mounting board or the like. If the frequency of the rotational vibration is close to the detuning frequency of the vibrating element, the detection vibrating arm resonates and its amplitude becomes very large, and the output signal of the detection circuit may be saturated. In this regard, the center voltage (zero-point voltage) of the output signal may shift and the detection accuracy of the angular velocity may be lower.

### SUMMARY

An advantage of some aspects of the invention is to provide a physical quantity detection circuit and a physical quantity detecting device that can reduce a possibility of lower detection accuracy even when a rotational vibration at a frequency closer to a detuning frequency of a vibrating element is applied, and an electronic apparatus and a moving object using the physical quantity detection circuit or the physical quantity detecting device.

The invention can be implemented as the following forms or application examples.

### Application Example 1

A physical quantity detection circuit according to this application example includes a detection part that detects a signal in response to a physical quantity contained in an output signal of a vibrating element based on a drive signal for driving the vibrating element, and a filter part provided at an upstream of the detection part, wherein the filter part has a cutoff frequency between a resonance frequency in a drive mode and a resonance frequency in a detection mode of the vibrating element and contains the resonance frequency in the drive mode in a passband.

According to the physical quantity detection circuit of this application example, when a rotational vibration at a frequency close to a detuning frequency defined as an absolute value of a difference between the resonance frequency in the drive mode and the resonance frequency in the detection mode of the vibrating element is applied in a direction of a detection axis of the vibrating element, the vibrating element outputs an unnecessary signal having a larger amplitude around the resonance frequency in the detection mode, and the unnecessary signal is removed (exactly, largely attenuated) by the filter part and the signal desired to be detected around the resonance frequency in the drive mode is input to the detection part. Therefore, according to the physical quantity detection circuit of this application example, even when the rotational vibration at the frequency close to the detuning frequency of the vibrating element is applied, a possibility of lower detection accuracy may be reduced.

Further, according to the physical quantity detection circuit of this application example, the unnecessary signal around the resonance frequency in the detection mode is removed before the detection part, and a possibility of saturation of the signal due to detection by the detection part may be reduced. Therefore, according to the physical quantity detection circuit of this application example, the higher detection accuracy is easily obtained than that in the case where the filter part is provided at the downstream of the detection part to remove the unnecessary signal due to the rotational vibration.

### Application Example 2

In the physical quantity detection circuit of the application example described above, the resonance frequency in the drive mode may be lower than the resonance frequency in the detection mode, and the filter part may be a low-pass filter having a cutoff frequency lower than the resonance frequency in the detection mode.

According to the physical quantity detection circuit of this application example, the filter part is the low-pass filter, and thereby, the unnecessary signal around the resonance frequency in the detection mode may be removed, and a signal desired to be detected around the resonance frequency in the drive mode lower than the resonance frequency in the detection mode may be detected.

### Application Example 3

In the physical quantity detection circuit of the application example described above, the resonance frequency in the drive mode may be higher than the resonance frequency in the detection mode, and the filter part may be a high-pass filter having a cutoff frequency higher than the resonance frequency in the detection mode.

According to the physical quantity detection circuit of this application example, the filter part is the high-pass filter, and thereby, the unnecessary signal around the resonance frequency in the detection mode may be removed, and a signal desired to be detected around the resonance frequency in the drive mode higher than the resonance frequency in the detection mode may be detected.

### Application Example 4

The physical quantity detection circuit of the application example described above may include a differential amplification part that differentially amplifies the output signal of the vibrating element, and an alternating-current amplification part provided between the differential amplification part and the detection part, and the filter part may be provided between the differential amplification part and the alternating-current amplification part.

According to the physical quantity detection circuit of this application example, the unnecessary signal around the resonance frequency in the detection mode may be removed before the alternating-current amplification part, and a possibility of saturation of the signal due to amplification by the AC amplification part may be reduced. Therefore, according to the physical quantity detection circuit of this application example, the higher detection accuracy is easily obtained than that in the case where the filter part is provided immediately before the detection part to remove the unnecessary signal due to the rotational vibration.

### Application Example 5

The physical quantity detection circuit of the application example described above may include a differential amplification part that differentially amplifies the output signal of the vibrating element, and an alternating-current amplification part provided between the differential amplification part and the detection part, and the filter part may be provided between the alternating-current amplification part and the detection part.

According to the physical quantity detection circuit of this application example, the unnecessary signal around the resonance frequency in the detection mode may be removed before the detection part, and a possibility of saturation of the signal due to detection by the detection part may be reduced. Therefore, according to the physical quantity detection circuit of this application example, the higher detection accuracy is easily obtained than that in the case where the filter part is provided at the downstream of the detection part to remove the unnecessary signal due to the rotational vibration.

### Application Example 6

A physical quantity detecting device according to this application example includes any one of the physical quantity detection circuits described above and the vibrating element.

According to the physical quantity detecting device of this application example, the unnecessary signal having the larger amplitude around the resonance frequency in the detection mode generated when the rotational vibration at the frequency close to the detuning frequency is applied in the direction of the detection axis of the vibrating element is removed by the filter part, the signal desired to be detected around the resonance frequency in the drive mode is detected, and thereby, even when the rotational vibration at the frequency close to the detuning frequency is applied, a possibility of lower detection accuracy may be reduced.

Further, according to the physical quantity detecting device of this application example, the unnecessary signal around the resonance frequency in the detection mode is removed before the detection part, and thereby, a possibility of saturation of the signal due to detection by the detection part may be reduced and the higher detection accuracy is easily obtained than that in the case where the filter part is provided at the downstream of the detection part to remove the unnecessary signal due to the rotational vibration.

### Application Example 7

An electronic apparatus according to this application example includes any one of the physical quantity detection circuits described above or the physical quantity detecting device described above.

### Application Example 8

A moving object according to this application example includes any one of the physical quantity detection circuits described above or the physical quantity detecting device described above.

The electronic apparatus and the moving object according to these application examples include the physical quantity detection circuit or the physical quantity detecting device with the reduced possibility of lowering detection accuracy even when the rotational vibration at the frequency close to the detuning frequency of the vibrating element is applied, and thereby, more reliable electronic apparatus and moving object may be realized.

### BRIEF DESCRIPTION OF THE DRAWINGS

The invention will be described with reference to the accompanying drawings, wherein like numbers reference like elements.

FIG. 1 is a functional block diagram of a physical quantity detecting device according to a first embodiment.

FIG. 2 is a plan view schematically showing a vibrating element according to the first embodiment.

FIG. 3 is a plan view schematically showing the vibrating element according to the first embodiment.

FIGS. 4A and 4B are plan views for explanation of movements of the vibrating element according to the first embodiment.

FIGS. 5A and 5B show examples of resonance characteristics of drive vibrating arms and resonance characteristics of detection vibrating arms.

FIG. 6 shows application of a rotational vibration to the physical quantity detecting device according to the first embodiment.

FIGS. 7A and 7B show examples of filter characteristics of a filter circuit according to the first embodiment.

FIG. 8 shows examples of signal waveforms when a rotational vibration is applied to the physical quantity detecting device.

FIG. 9 is a plan view schematically showing a vibrating element according to a second embodiment.

FIG. 10 is a plan view schematically showing the vibrating element according to the second embodiment.

FIGS. 11A and 11B are plan views for explanation of movements of the vibrating element according to the second embodiment.

FIG. 12 shows application of a rotational vibration to the physical quantity detecting device according to the second embodiment.

FIG. 13 is a functional block diagram of a physical quantity detecting device according to a third embodiment.

FIG. 14 shows an example of filter characteristics of a filter circuit according to a fourth embodiment.

FIG. 15 is a perspective view schematically showing an electronic apparatus according to the embodiment.

FIG. 16 is a perspective view schematically showing an electronic apparatus according to the embodiment.

FIG. 17 is a perspective view schematically showing an electronic apparatus according to the embodiment.

FIG. 18 is a perspective view schematically showing a moving object according to the embodiment.

### DESCRIPTION OF EXEMPLARY EMBODIMENTS

As below, embodiments of the invention will be explained in detail using the drawings. The embodiments to be explained do not unduly limit the invention described in the appended claims, and not all of the configurations to be explained are not essential component elements of the invention.

As below, a physical quantity detecting device that detects an angular velocity as a physical quantity will be explained as an example, however, the invention includes physical quantity detecting devices that detect other physical quantities than the angular velocity.

### 1. Physical Quantity Detecting device

### 1-1. First Embodiment

### Functional Configuration of Physical Quantity Detecting Device

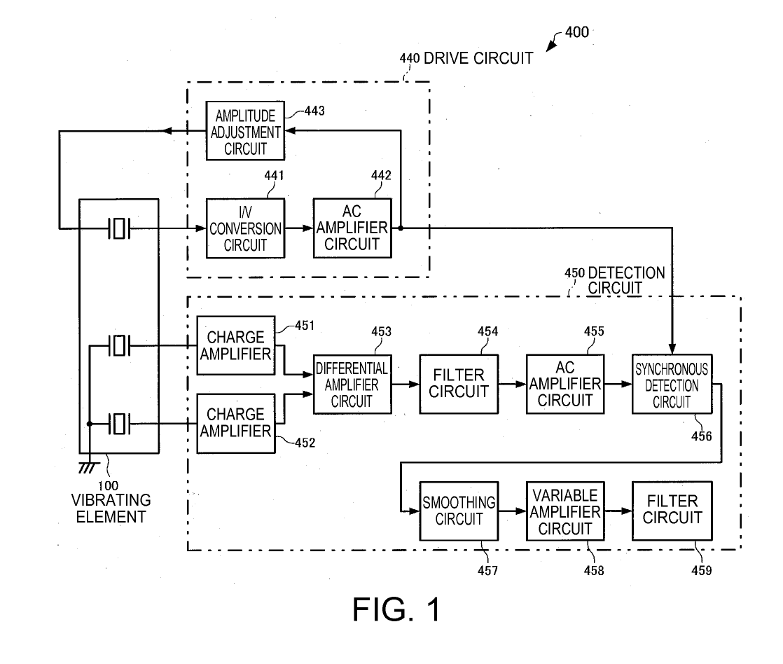

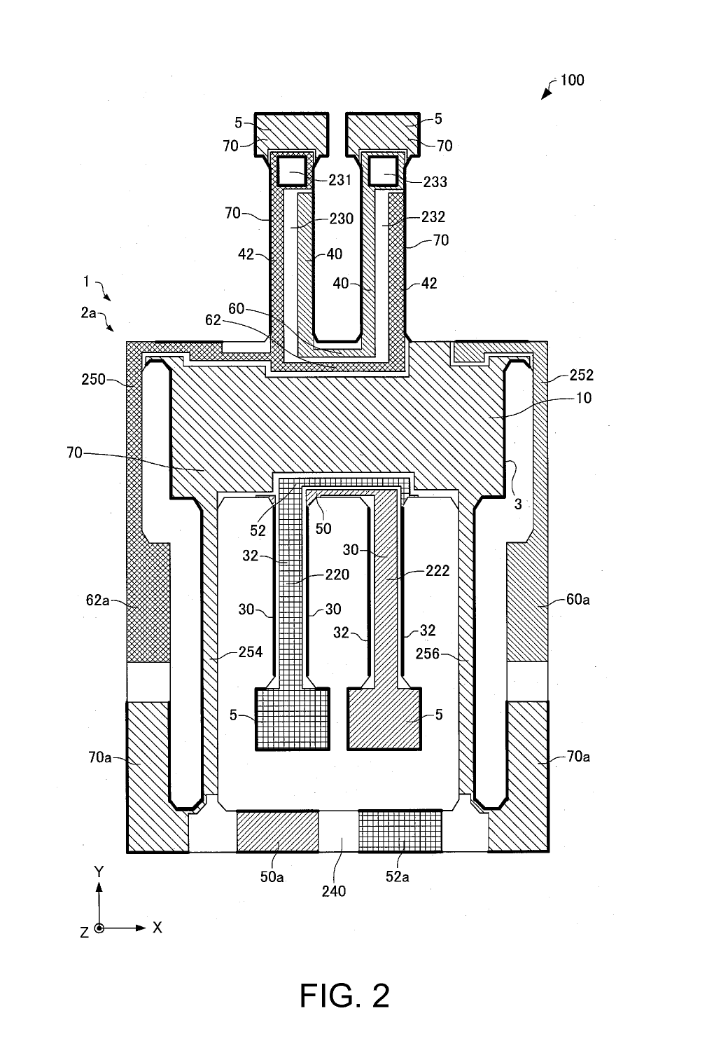

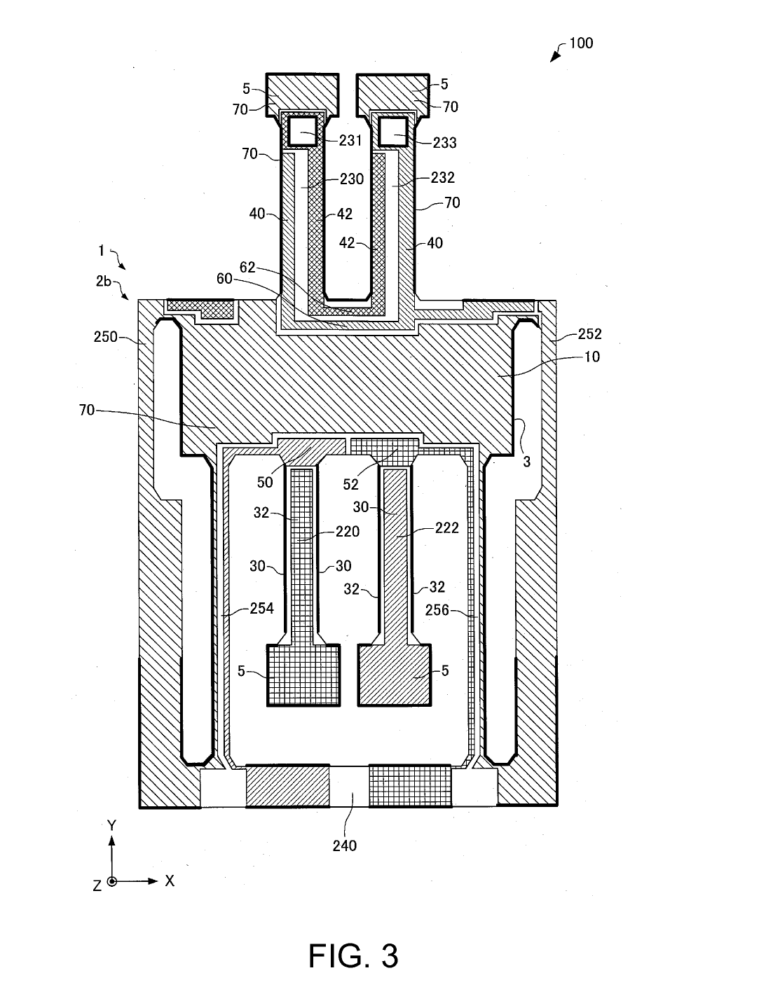

FIG. 1 is a functional block diagram of a physical quantity detecting device according to the first embodiment. As shown in FIG. 1, a physical quantity detecting device 400 according to the embodiment includes a vibrating element 100, a drive circuit 440 for driving to vibrate drive vibrating arms 220, 222 (see FIGS. 2 and 3) of the vibrating element 100, and a detection circuit 450 (an example of a physical quantity detection circuit) for detecting detection vibrations generated in detection vibrating arms 230, 232 of the vibrating element 100 when an angular velocity (an example of physical quantity) is applied. The drive circuit 440 and the detection circuit 450 may be realized by a one-chip IC or respectively realized by individual IC chips.

The drive circuit 440 has an I/V conversion circuit (current-voltage conversion circuit) 441, an AC amplifier circuit (alternating-current amplifier circuit) 442, and an amplitude adjustment circuit 443. The drive circuit 440 is a circuit from which signals for driving the drive vibrating arms 220, 222 are output to drive input electrodes 30 (see FIGS. 2 and 3) of the vibrating element 100 and to which signals output from drive output electrodes 32 (see FIGS. 2 and 3) of the vibrating element 100 are input. As below, the drive circuit 440 will be explained in detail.

When the drive vibrating arms 220, 222 of the vibrating element 100 vibrate, alternating currents based on the piezoelectric effect are output from the drive output electrodes 32 and input to the I/V conversion circuit 441. The I/V conversion circuit 441 converts the input alternating currents into alternating-current voltage signals at the same frequency as the vibration frequency of the drive vibrating arms 220, 222 and output the signals.

The alternating-current voltage signals output from the I/V conversion circuit 441 are input to the AC amplifier circuit 442. The AC amplifier circuit 442 amplifies and outputs the input alternating-current voltage signals.

The alternating-current voltage signals output from the AC amplifier circuit 442 are input to the amplitude adjustment circuit 443. The amplitude adjustment circuit 443 controls gain to hold the amplitudes of the input alternating-current voltage signals at a constant value, and outputs the gain-controlled alternating-current voltage signals to the drive input electrodes 30 of the vibrating element 100. By the alternating-current voltage signals (drive signals) input to the drive input electrodes 30, the drive vibrating arms 220, 222 vibrate.

The detection circuit 450 has a charge amplifier 451, a charge amplifier 452, a differential amplifier circuit 453, a filter circuit 454, an AC amplifier circuit 455, a synchronous detection circuit 456, a smoothing circuit 457, a variable amplifier circuit 458, and a filter circuit 459. The detection circuit 450 is a circuit that detects an angular velocity based on signals respectively output from first detection electrodes 40 and second detection electrodes 42 (see FIGS. 2 and 3) of the vibrating element 100. As below, the detection circuit 450 will be explained in detail.

When a first detection signal (alternating current) output from the first detection electrode 40 is input, the charge amplifier 451 converts the input first detection signal (alternating current) into an alternating-current voltage signal.

When a second detection signal (alternating current) output from the second detection electrode 42 is input, the charge amplifier 452 converts the input second detection signal (alternating current) into an alternating-current voltage signal.

The first detection signal and the second detection signal are opposite in electrical characteristics.

The output signal of the charge amplifier 451 and the output signal of the charge amplifier 452 are input to the differential amplifier circuit 453.

The differential amplifier circuit 453 functions as a differential amplification part that differentially amplifies the output signal of the vibrating element 100, and outputs a signal formed by amplifying (differentially amplifying) the potential difference between the output signal of the charge amplifier 451 and the output signal of the charge amplifier 452. The output signal of the differential amplifier circuit 453 is input to the filter circuit 454.

The filter circuit 454 functions as a filter part having a cutoff frequency f_{c} between a resonance frequency f_{dr} in a drive mode (resonance frequency of the drive vibrating arms 220, 222 (see FIGS. 2 and 3)) and a resonance frequency f_{dt} in a detection mode (resonance frequency of the detection vibrating arms 230, 232 (see FIGS. 2 and 3)) of the vibrating element 100 and containing the resonance frequency f_{dr} in the drive mode in the passband. The filter circuit 454 is formed as a low-pass filter when the vibrating element 100 has a relationship of f_{dr}<f_{dt} and formed as a high-pass filter when the vibrating element 100 has a relationship of f_{dr}>f_{dt}. The output signal of the filter circuit 454 is input to the AC amplifier circuit 455.

The AC amplifier circuit 455 functions as an AC amplification part (alternating-current amplification part) that amplifies an AC signal (alternating-current signal) and outputs a signal formed by amplifying the output signal of the filter circuit 454. The output signal of the AC amplifier circuit 455 is input to the synchronous detection circuit 456.

The synchronous detection circuit 456 functions as a detection part that detects the signal in response to the angular velocity contained in the output signal of the vibrating element 100 based on the drive signal for driving the vibrating element 100. Specifically, the synchronous detection circuit 456 synchronously detects the output signal of the AC amplifier circuit 455 based on the alternating-current voltage signal output by the AC amplifier circuit 442 of the drive circuit 440, and thereby, extracts an angular velocity component.

The signal of the angular velocity component extracted in the synchronous detection circuit 456 is smoothed into a direct-current voltage signal in the smoothing circuit 457, and input to the variable amplifier circuit 458.

The variable amplifier circuit 458 amplifies (or attenuates) the output signal (direct-current voltage signal) of the smoothing circuit 457 at a preset amplification factor (or attenuation factor) to change the angular velocity sensitivity. The signal amplified (or attenuated) in the variable amplifier circuit 458 is input to the filter circuit 459.

The filter circuit 459 removes noise components out of the sensor band from the output signal of the variable amplifier circuit 458 (exactly, attenuates to a predetermined level or less), and outputs a detection signal with polarity and at voltage level in response to the direction and the magnitude of the angular velocity. Then, the detection signal is output to the outside from an external output terminal (not shown).

### Configuration of Vibrating Element

Next, the vibrating element 100 according to the first embodiment will be explained with reference to the drawings. FIGS. 2 and 3 are plan views schematically showing the vibrating element 100 according to the first embodiment. Note that, in FIGS. 2 and 3 and the following drawings, an X-axis (first axis), a Y-axis (second axis), and a Z-axis (third axis) are shown as three axes orthogonal to one another.

FIG. 2 shows the vibrating element 100 as seen from a first principal surface 2a side for explanation of a configuration on the first principal surface 2a side. FIG. 3 is a transparent view of the vibrating element 100 as seen from the first principal surface 2a side for explanation of a configuration on a second principal surface 2b side.

As shown in FIGS. 2 and 3, the vibrating element 100 has a base part 10, the drive vibrating arms 220, 222, the detection vibrating arms 230, 232, a support part 240, beam parts 250, 252, 254, 256, the drive input electrodes 30, the drive output electrodes 32, the detection electrodes 40, 42, drive input lines 50, drive output lines 52, detection lines 60, 62, and fixed potential lines 70.

The base part 10, the drive vibrating arms 220, 222, the detection vibrating arms 230, 232, the support part 240, and the beam parts 250, 252, 254, 256 form a vibrating reed 1. The material of the vibrating reed 1 is a piezoelectric material including e.g., crystal, lithium tantalate, lithium niobate, etc. The vibrating reed 1 has the first principal surface 2a and the second principal surface 2b directed in opposite directions to each other, and side surfaces 3 connected to the principal surfaces 2a, 2b. In the illustrated example, the first principal surface 2a is the surface directed in the +Z-axis direction, the second principal surface 2b is the surface directed in the −Z-axis direction, and the side surfaces 3 are the surfaces having normal orthogonal to the Z-axis. The principal surfaces 2a, 2b are e.g., flat surfaces. The thickness of the vibrating reed 1 (the size in the Z-axis directions) is e.g., about 100 μm.

The first drive vibrating arm 220 and the second drive vibrating arm 222 extend from the base part 10 along the Y-axis. In the illustrated example, the drive vibrating arms 220, 222 extend from the base part 10 in the −Y-axis direction. The drive vibrating arms 220, 222 are arranged side by side along the X-axis. In the illustrated example, the first drive vibrating arm 220 is provided nearer the side in the −X-axis direction than the second drive vibrating arm 222.

The first detection vibrating arm. 230 and the second detection vibrating arm 232 extend from the base part 10 in the opposite direction to the extension direction of the drive vibrating arms 220, 222. In the illustrated example, the detection vibrating arms 230, 232 extend from the base part 10 in the +Y-axis direction. The detection vibrating arms 230, 232 are arranged side by side along the X-axis. In the illustrated example, the first detection vibrating arm 230 is provided nearer the side in the −X-axis direction than the second detection vibrating arm 232.

A through hole 231 is provided in the first detection vibrating arm 230. By the through hole 231, the second detection electrode 42 provided on the first principal surface 2a and the second detection electrode 42 provided on the second principal surface 2b may be conducted. A through hole 233 is provided in the second detection vibrating arm 232. By the through hole 233, the first detection electrode 40 provided on the first principal surface 2a and the first detection electrode 40 provided on the second principal surface 2b may be conducted.

Wider parts 5 are provided on ends of the vibrating arms 220, 222, 230, 232. The wider parts 5 have larger widths (sizes in the X-axis directions) than the other parts of the vibrating arms 220, 222, 230, 232. Though not illustrated, weight parts may be provided in the wider parts 5. By adjustment of the masses of the weights parts, the frequencies of the vibrations of the vibrating arms 220, 222, 230, 232 may be adjusted.

The support part 240 is provided nearer the side in the −Y-axis direction than the base part 10. The support part 240 is a part fixed to a package when the vibrating element 100 is mounted. The support part 240 supports the base part 10 via the beam parts 250, 252, 254, 256.

The first beam part 250 and the second beam part 252 respectively extend from the base part 10 to the support part 240 and connect the base part 10 and the support part 240.

The third beam part 254 and the second beam part 256 respectively extend from the base part 10 to the support part 240 and connect the base part 10 and the support part 240.

Thereby, the support part 240 may support the base part 10 via the beam parts 250, 252, 254, 256 without hindering vibrations of the vibrating arms 220, 222, 230, 232.

The drive input electrodes 30, the drive output electrodes 32, the first detection electrodes 40, the second detection electrodes 42, the drive input lines 50, the drive output lines 52, the first detection lines 60, and the second detection lines 62 are formed by lamination from the vibrating reed 1 side in the order of chromium and gold, for example.

The drive input electrodes 30 are provided on the drive vibrating arms 220, 222. In the illustrated example, the drive input electrodes 30 are provided on the side surfaces 3 of the first drive vibrating arm 220 and the principal surfaces 2a, 2b of the second drive vibrating arm 222. The drive input electrodes 30 are electrodes to which signals (drive signals) for driving the drive vibrating arms 220, 222 are input.

The drive output electrodes 32 are provided on the drive vibrating arms 220, 222. In the illustrated example, the drive output electrodes 32 are provided on the principal surfaces 2a, 2b of the first drive vibrating arm 220 and the side surfaces 3 of the second drive vibrating arm 222. The drive output electrodes 32 are electrodes from which signals based on bending of the drive vibrating arms 220, 222 are output.

The first detection electrodes 40 are provided on the detection vibrating arms 230, 232. In the illustrated example, the first detection electrodes 40 are provided on the principal surfaces 2a, 2b of the first detection vibrating arm 230, and the principal surfaces 2a, 2b, the side surfaces 3, and the inner surface of the through hole 233 of the second detection vibrating arm 232. The first detection electrodes are electrodes for detecting signals (first detection signals) based on bending of the detection vibrating arms 230, 232 by Coriolis force.

The second detection electrodes 42 are provided on the detection vibrating arms 230, 232. In the illustrated example, the second detection electrodes 42 are provided on the principal surfaces 2a, 2b and the inner surface of the through hole 231 of the first detection vibrating arm. 230, and the principal surfaces 2a, 2b and the side surfaces 3 of the second detection vibrating arm 232. The second detection electrodes 42 are electrodes for detecting signals (second detection signals) based on bending of the detection vibrating arms 230, 232 by Coriolis force.

Note that, though not illustrated, groove portions may be provided on the principal surfaces 2a, 2b of the vibrating arms 220, 222, 230, 232, and the electrodes 30, 32, 40, 42 may be provided within the groove portions.

The drive input lines 50 are provided on the base part 10, the support part 240, and the third beam part 254. The drive input lines 50 have a terminal portion 50a on the support part 240 and connect the terminal portion 50a and the drive input electrodes 30. In the illustrated example, the planar shape of the terminal portion 50a is a rectangular shape. The terminal portion 50a is connected to an external member (e.g., bonding wire), and the drive signals output from the drive circuit 440 are input to the drive input electrodes 30 via the external member and the drive input lines 50.

The drive output lines 52 are provided on the base part 10, the support part 240, and the fourth beam part 256. The drive input lines 52 have a terminal portion 52a on the support part 240 and connect the terminal portion 52a and the drive output electrodes 32. In the illustrated example, the planar shape of the terminal portion 52a is a rectangular shape. The terminal portion 52a is connected to an external member (e.g., bonding wire), and the signals output from the drive output electrodes 32 are input to the drive circuit 440 via the drive output lines 52 and the external member.

The first detection lines 60 are provided on the base part 10, the support part 240, and the second beam part 252. The first detection lines 60 have a terminal portion 60a on the support part 240 and connect the terminal portion 60a and the first detection electrodes 40. The terminal portion 60a is connected to an external member (e.g., bonding wire), and the first detection signals output from the first detection electrodes 40 are input to the charge amplifier 451 of the detection circuit 450 via the first detection lines 60 and the external member.

The second detection lines 62 are provided on the base part 10, the support part 240, and the first beam part 250. The second detection lines 62 have a terminal portion 62a on the support part 240 and connect the terminal portion 62a and the second detection electrodes 42. The terminal portion 62a is connected to an external member (e.g., bonding wire), and the second detection signals output from the second detection electrodes 42 are input to the charge amplifier 452 of the detection circuit 450 via the second detection lines 62 and the external member.

The fixed potential lines 70 are provided on the base part 10, the support part 240, and the beam parts 250, 252, 254, 256. In the illustrated example, the fixed potential lines 70 are also provided on the side surfaces 3 and the wider parts 5 of the detection vibrating arms 230, 232. The fixed potential lines 70 are lines to which a fixed potential is input. Specifically, the fixed potential lines 70 have the ground potential. That is, the fixed potential lines 70 are grounded.

Note that, in FIGS. 2 and 3, the electrodes 30, 32, 40, 42 and the lines 50, 52, 60, 62, 70 provided on the side surfaces 3 of the vibrating reed 1 are shown by thick lines.

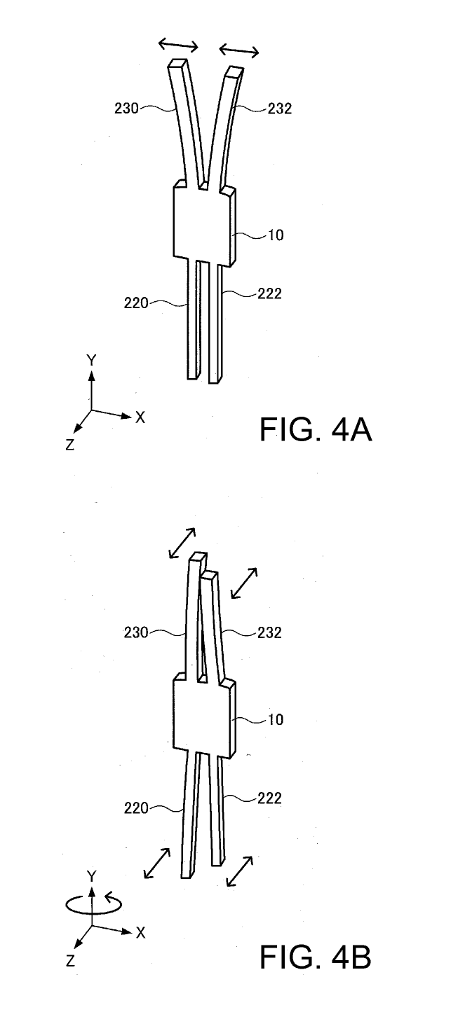

Next, movements of the vibrating element 100 will be explained. FIGS. 4A and 4B are perspective views for explanation of the movements of the vibrating element 100. Note that, for convenience, illustration of the other members than the base part 10 and the vibrating arms 220, 222, 230, 232 is omitted in FIGS. 4A and 4B.

As shown in FIG. 4A, under a condition that no angular velocity is applied to the vibrating element 100, when a predetermined alternating-current voltage is applied to the drive input electrodes 30 provided on the drive vibrating arms 220, 222, the arms perform bending movements in opposite directions to each other within the XY plane.

Under the condition that the drive vibrating arms 220, 222 are driven to vibrate, when an angular velocity about the Y-axis is applied to the vibrating element 100, Coriolis force in response to the angular velocity acts and the drive vibrating arms 220, 222 perform bending movements oppositely to each other in the Z-axis directions.

The Coriolis force applied when an object having a mass m moving at a velocity v rotates at an angular velocity Ω is expressed by the following formula (1).

F_{c}=−2mνΩ (1)

Supposing that the vibration frequency of the drive vibrating arms 220, 222 in the drive mode is f_{dr} and the maximum amplitude is A, the velocity v of the drive vibrating arms 220, 222 is expressed by the following formula (2) using a time variable t.

ν=2πf_{dr}A cos(2πf_{dr}t) (2)

Therefore, supposing that the mass of the drive vibrating arms 220, 222 is m, the formula (2) is substituted into the formula (1), and the Coriolis force applied to the drive vibrating arms 220, 222 is expressed by the following formula (3).

F_{c}=−4πmAΩf_{dr} cos(2πf_{dr}t) (3)

When rotation at the angular velocity Ω is applied, the drive vibrating arms 220, 222 perform bending vibrations due to application of the Coriolis force expressed by the formula (3), and the detection vibrating arms 230, 232 perform bending vibrations oppositely to each other in the Z-axis directions in resonance with the bending vibrations. By the vibrations (bending vibrations) of the detection vibrating arms 230, 232, the first detection signals and the second detection signals are generated in the first detection electrodes 40 and the second detection electrodes 42, respectively.

In this regard, the electric polarity of the first detection signals and the electric polarity of the second detection signals are opposite. For example, when positive charge δ+ is generated in the first detection electrodes 40, negative charge δ− is generated in the second detection electrodes 42, and, when negative charge δ− is generated in the first detection electrodes 40, positive charge δ+ is generated in the second detection electrodes 42. The first detection signals are output from the terminal portion 60a to the detection circuit 450 and the second detection signals are output from the terminal portion 62a to the detection circuit 450, and the detection circuit 450 may obtain the angular velocity about the Y-axis using these detection signals.

Hereinafter, the state without detection of the angular velocity as shown in FIG. 4A is referred to as “drive mode” and the state with detection of the angular velocity as shown in FIG. 4B is referred to as “detection mode”.

### Relationships Between Detuning Frequency and Vibration Frequency of Mounting Board

The resonance frequency f_{dr} in the drive mode is determined depending on the length, thickness, material, etc. of the drive vibrating arms 220, 222, and the resonance frequency f_{dt} in the detection mode is determined depending on the length, thickness, material, etc. of the detection vibrating arms 230, 232. The difference between the resonance frequency f_{dr} in the drive mode and the resonance frequency f_{dt} in the detection mode is called a detuning frequency.

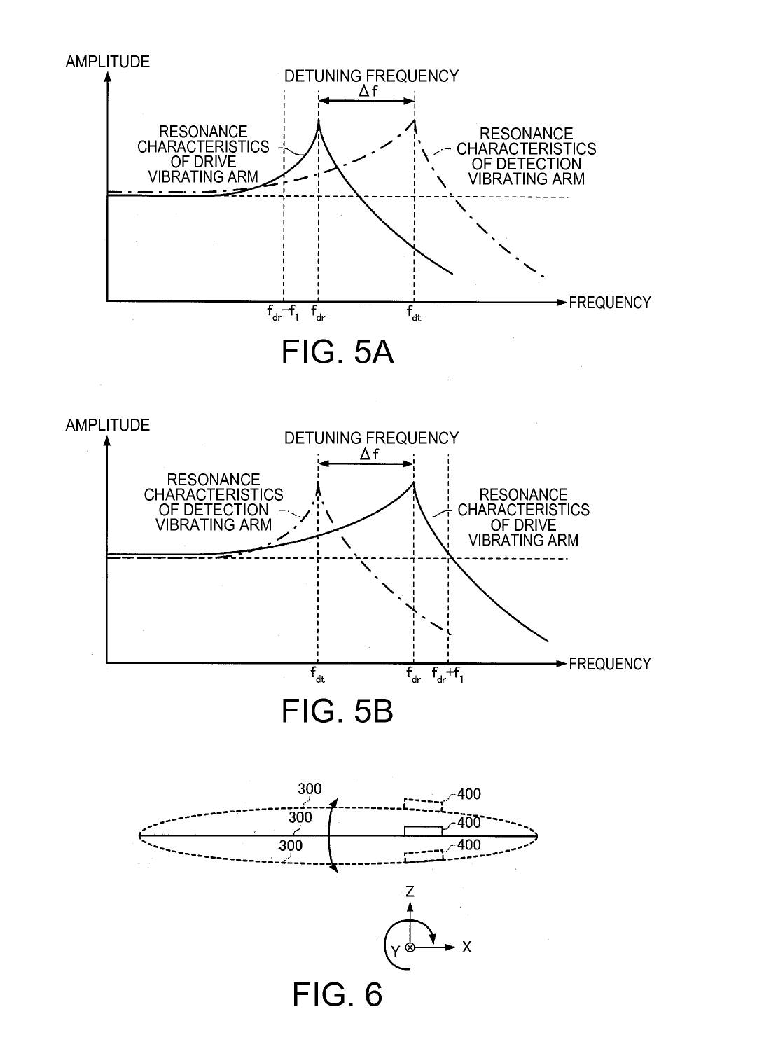

FIGS. 5A and 5B show examples of resonance characteristics of the drive vibrating arms 220, 222 and resonance characteristics of the detection vibrating arms 230, 232. FIG. 5A shows the example when f_{dr}<f_{dt}, and the detuning frequency Δf=f_{dt}−f_{dr}. On the other hand, FIG. 5B shows the example when f_{dr}>f_{dt}, and the detuning frequency Δf=f_{dr}−f_{dt}.

In the drive mode, the drive vibrating arms 220, 222 vibrate at the resonance frequency f_{dr} by the drive signals output by the drive circuit 440. In the detection mode, the drive vibrating arms 220, 222 also vibrate at the resonance frequency f_{dr} and the resonance frequency f_{dr} excites vibrations of the detection vibrating arms 230, 232 at the resonance frequency f_{dr}, and thereby, the detection vibrating arms 230, 232 also vibrate at the resonance frequency f_{dr}. As the resonance frequency f_{dr} in the drive mode is closer to the resonance frequency f_{dt} in the detection mode, that is, as the detuning frequency Δf is lower, the amplitude of the detection vibrating arms 230, 232 is larger and the amounts of charge generated in the detection electrodes 40, 42 are larger, and the element sensitivity is higher. Namely, the element sensitivity is inversely proportional to the detuning frequency Δf. However, as the detuning frequency Δf is lower, the amplitude of the detection vibrating arms 230, 232 is larger and various problems such that the detection vibrating arms 230, 232 are easier to break easily occur. Accordingly, it is desired that the detuning frequency Δf is made as high as possible, but the detuning frequency Δf should be made lower to some degree because the detection sensitivity of the angular velocity becomes lower with the lower element sensitivity.

Now, the physical quantity detecting device 400 is mounted on a printed board or the like, and, depending on the installation environment of the mounting board, for example, the mounting board may vibrate in the direction perpendicular to the principal surface. FIG. 6 schematically shows a vibration of the mounting board. As shown in FIG. 6, when a mounting board 300 vibrates, the physical quantity detecting device 400 performs a minute rotational vibration in the periodically changing rotation direction, and an angular velocity in the direction of the detection axis (Y-axis) may be applied to the vibrating element 100.

When the mounting board 300 rotationally vibrates at a frequency f₁ with the maximum amplitude Ω₁ about the detection axis (Y-axis) of the vibrating element 100, the angular velocity Ω applied to the vibrating element 100 is expressed by the following formula (4) using the time variable t.

Ω=Ω₁ cos(2πf₁t) (4)

By substitution of the formula (4) into the formula (3), Coriolis force applied to the drive vibrating arms 220, 222 is expressed by the following formula (5).

$$\begin{matrix}\begin{matrix}{F}_{c} = - 4 π m A {Ω}_{1} {f}_{dr} cos ( 2 π {f}_{dr} t ) cos ( 2 π {f}_{1} t ) \\ = - 2 π m A {Ω}_{1} {f}_{dr} \{ cos ( 2 π ( {f}_{dr} + {f}_{1} ) t ) + cos ( 2 π ( {f}_{dr} - {f}_{1} ) t ) \}\end{matrix} & ( 5 )\end{matrix}$$

Therefore, from the formula (5), vibrations of the detection vibrating arms 230, 232 are excited at two drive frequencies of f_{dr}+f₁ and f_{dr}−f₁, and the first detection signals and the second detection signals contain the two frequency components of f_{dr}+f₁ and f_{dr}−f₁.

Here, as is clear from FIGS. 5A and 5B, when the vibration frequency f₁ of the mounting board 300 is close to the detuning frequency Δf, if f_{dr}<f_{dt} (see FIG. 5A), the Coriolis force by f_{dr}−f₁ is at the frequency far from the resonance frequency f_{dt} of the detection vibrating arms 230, 232, and the detection vibration by the frequency f_{dr}−f₁ is sufficiently negligibly minute. Similarly, if f_{dr}>f_{dt} (see FIG. 5B), the Coriolis force by f_{dr}+f₁ is also at the frequency far from the resonance frequency f_{dt} of the detection vibrating arms 230, 232, and the detection vibration by the frequency f_{dr}+f₁ is sufficiently negligibly minute.

On the other hand, when the vibration frequency f₁ of the mounting board 300 is close to the detuning frequency Δf, if f_{dr}<f_{dt} (see FIG. 5A), f_{dr}+f₁ is close to f_{dt} and if f_{dr}>f_{dt} (see FIG. 5B), f_{dr}−f₁ is close to f_{dt}, and the detection vibrating arms 230, 232 largely vibrate at the frequency close to the resonance frequency f_{dt}. Then, the amounts of charge generated in the detection electrodes 40, 42 become too large, and there is a possibility that the output signals of the differential amplifier circuit 453 and the output signals of the AC amplifier circuit 455 may be saturated. Further, if saturation is not caused with the output signals of the AC amplifier circuit 455, but if these signals are input to the synchronous detection circuit 456 and synchronously detected, there is a possibility that the output signals of the detection circuit 450 may be saturated.

For example, when a rotational vibration at 100 dps having a frequency component around the detuning frequency Δf is applied to the vibrating element 100, if the rotation is multiplied by 500 by resonance of the detection vibrating arms 230, 232, the detection signals at 50000 dps are output. In the case where the dynamic range of the output signals of the detection circuit 450 is designed on the assumption of ±300 dps, when the detection signals at 50000 dps are input, the output signals of the detection circuit 450 are saturated.

When the output signals of the detection circuit 450 are saturated at the maximum output voltage, the center voltage (zero-point voltage) shifts to be lower and when the output signals of the detection circuit 450 are saturated at the minimum output voltage, the center voltage (zero-point voltage) shifts to be higher. Both cases lead to reduction in detection accuracy and erroneous detection.

Particularly, in the physical quantity detecting device 400 according to the embodiment, the Y-axis in parallel to the principal surfaces 2a, 2b of the vibrating element 100 is the detection axis, and, when the element is mounted with the principal surfaces 2a, 2b in parallel to the mounting board 300, the detection axis is easily aligned with the vibration direction of the mounting board 300 and there is a possibility that the output signals of the detection circuit 450 may be saturated.

Accordingly, in the embodiment, the filter circuit 454 is provided at the upstream of the AC amplifier circuit 455 so that the filter circuit 454 may remove (exactly, largely attenuate) the signals at the frequency components close to the resonance frequency f_{dt} of the detection vibrating arms 230, 232.

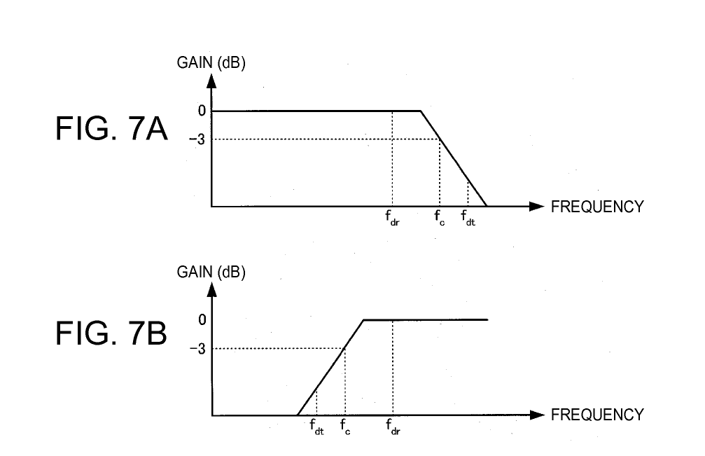

Specifically, when the structure of the vibrating element 100 is determined so that f_{dr}<f_{dt} may be satisfied, the filter circuit 454 is formed as a low-pass filter. Then, the filter circuit 454 is formed so that the filter characteristics as shown in FIG. 7A may be obtained, that is, the passband may contain f_{dr} and the cutoff frequency f_{c} may be f_{c}<f<f_{dt}. According to the configuration, the signals at the frequency component f_{dr}+f₁ contained in the detection signals of the vibrating element 100 are removed by the filter circuit 454 and only the signals at the frequency component f_{dr}−f₁ are synchronously detected with the signal at the frequency f_{dr} in the synchronous detection circuit 456, and thus, the output signal S of the synchronous detection circuit 456 is expressed by the following formula (6). Here, α is a constant number in the formula (6).

$$\begin{matrix}\begin{matrix}S = α \cdot cos ( 2 π ( {f}_{dr} - {f}_{1} ) t ) \cdot cos ( 2 π {f}_{dr} t ) \\ = \frac{α}{2} \cdot \{ cos ( 2 π ( 2 {f}_{dr} - {f}_{1} ) t ) + cos ( 2 π {f}_{1} t ) \}\end{matrix} & ( 6 )\end{matrix}$$

The signal at the frequency 2f_{dr}−f₁ of the first term on the right side of the formula (6) is removed by the smoothing circuit 457, and only the signal at the frequency f₁ of the second term on the right side is left in the output signal of the smoothing circuit 457.

On the other hand, when the structure of the vibrating element 100 is determined so that f_{dr}>f_{dt} may be satisfied, the filter circuit 454 is formed as a high-pass filter. Then, the filter circuit 454 is formed so that the filter characteristics as shown in FIG. 7B may be obtained, that is, the passband may contain f_{dr} and the cutoff frequency f_{c} may be f_{c}>f_{dt}. According to the configuration, the signals at the frequency component f_{dr}−f₁ contained in the detection signals of the vibrating element 100 are removed by the filter circuit 454 and only the signals at the frequency component f_{dr}+f₁ are synchronously detected with the signal at the frequency f_{dr} in the synchronous detection circuit 456, and thus, the output signal S of the synchronous detection circuit 456 is expressed by the following formula (7). Here, α is a constant number in the formula (7).

$$\begin{matrix}\begin{matrix}S = α \cdot cos ( 2 π ( {f}_{dr} + {f}_{1} ) t ) \cdot cos ( 2 π {f}_{dr} t ) \\ = \frac{α}{2} \cdot \{ cos ( 2 π ( 2 {f}_{dr} + {f}_{1} ) t ) + cos ( 2 π {f}_{1} t ) \}\end{matrix} & ( 7 )\end{matrix}$$

The signal at the frequency 2f_{dr}+f₁ of the first term on the right side of the formula (7) is removed by the smoothing circuit 457, and only the signal at the frequency f₁ of the second term on the right side is left in the output signal of the smoothing circuit 457.

Note that, in either case where the filter circuit 454 is formed as the low-pass filter or the high-pass filter, the cutoff frequency f_{c} of the filter circuit 459 (low-pass filter) may be set to be sufficiently smaller than the detuning frequency Δf and the signal at the frequency f₁ left in the output signal of the smoothing circuit 457 may be removed by the filter circuit 459.

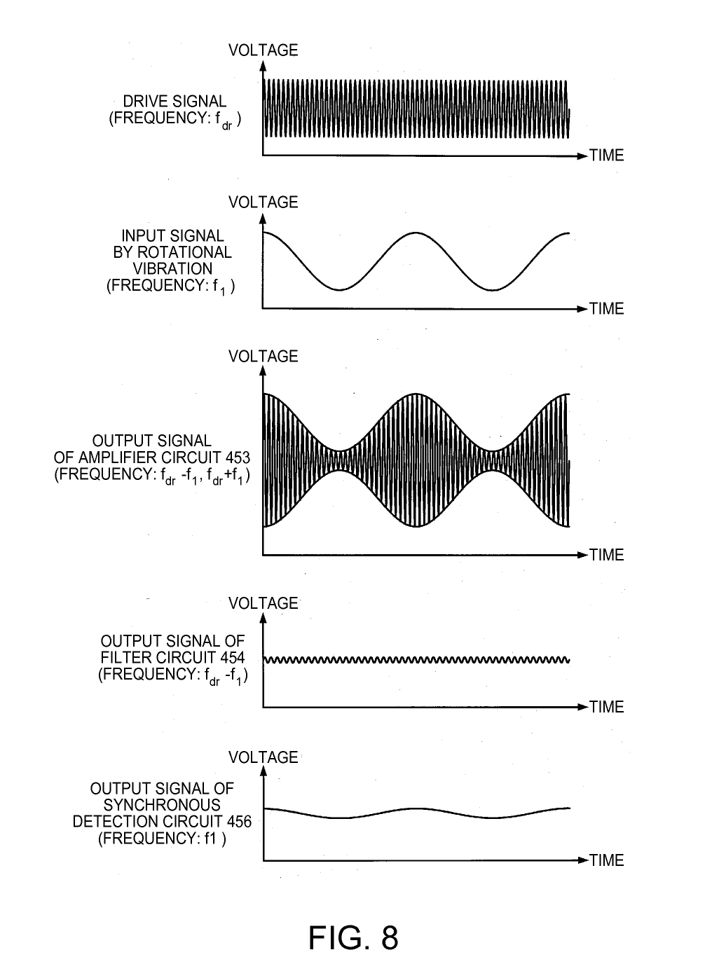

FIG. 8 shows examples of signal waveforms observed when a rotational vibration at the frequency f₁ is applied to the vibrating element 100 in the case where f_{dr}<f_{dt} and the filter circuit 454 is formed as the low-pass filter. As shown in FIG. 8, the output signals of the differential amplifier circuit 453 are relatively large signals formed by amplitude modulation of the drive signal at the frequency f_{dr} with the signal at the frequency f₁ by the rotational vibration, however, the output signals of the filter circuit 454 are small signals at the frequency f_{dr}−f₁ and the output signals of the synchronous detection circuit 456 are small signals at the frequency f₁, and the output signals of the detection circuit 450 are not saturated.

As explained above, according to the physical quantity detecting device 400 of the first embodiment, the filter circuit 454 is provided, and thereby, even when the rotational vibration or impact at the frequency close to the detuning frequency Δf of the vibrating element 100 is applied, the possibility of saturation of the output signals of the detection circuit 450 may be reduced. Therefore, variations of the center voltage (zero-point voltage) in the output signals of the detection circuit 450 are suppressed, and thereby, the strong physical quantity detecting device 400 with higher detection accuracy, robustness to vibrations and impacts, and the higher degree of freedom of the mounting position may be realized.

Particularly, the filter circuit 454 is provided at the upstream of the AC amplifier circuit 455, and thereby, the possibility of saturation of the output signals of the AC amplifier circuit 455 and the possibility of saturation of the output signals of the synchronous detection circuit 456 may be reduced, and the configuration is advantageous compared to the case where the signals at the frequency f₁ by the rotational vibration are removed by the smoothing circuit 457.

### 1-2. Second Embodiment

A physical quantity detecting device 400 according to the second embodiment is different from that of the first embodiment in the structure of the vibrating element 100. Note that the functional block diagram of the physical quantity detecting device according to the second embodiment is the same as FIG. 1 and the illustration and explanation will be omitted.

### Configuration of Vibrating Element

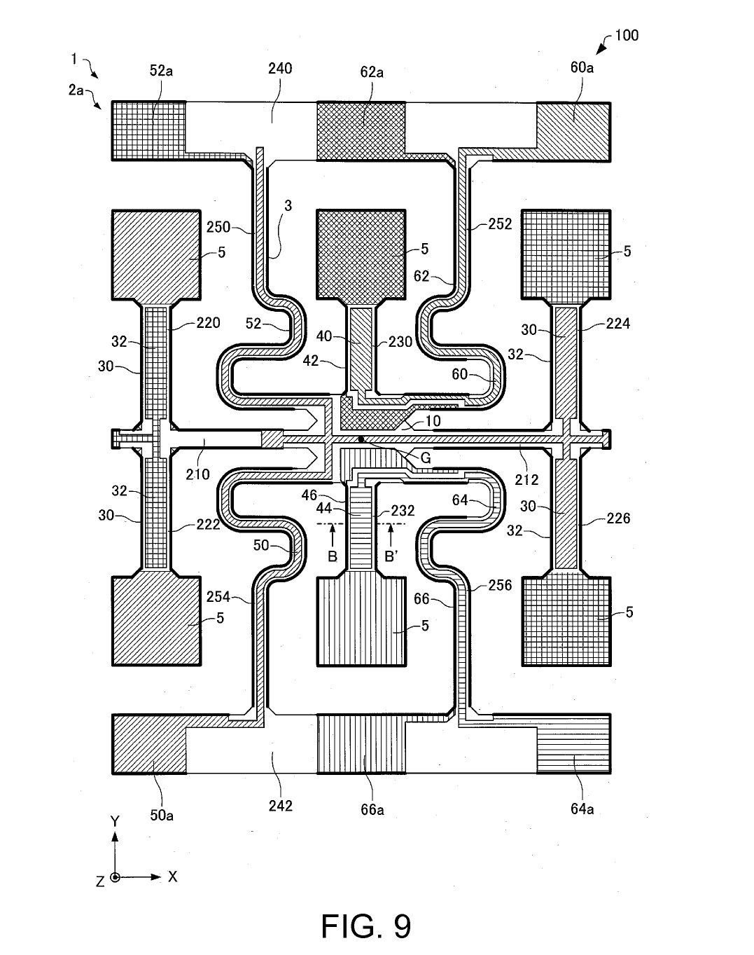

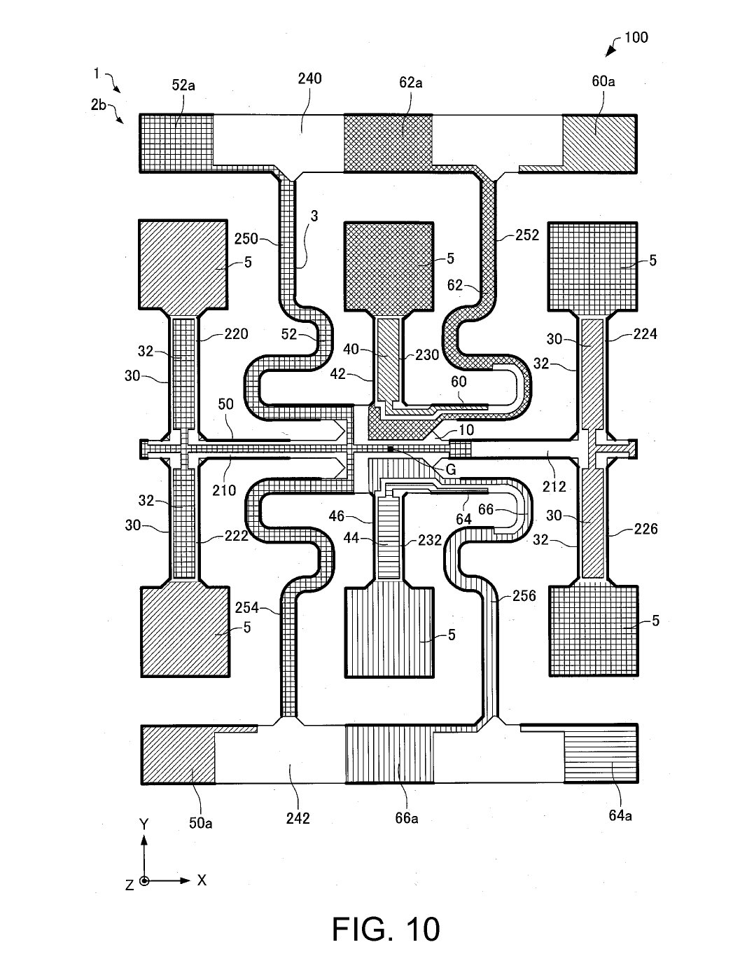

A vibrating element 100 according to the second embodiment will be explained with reference to the drawings. FIGS. 9 and 10 are plan views schematically showing the vibrating element 100 according to the second embodiment.

Note that FIG. 9 shows the vibrating element 100 as seen from a first principal surface 2a side for explanation of the configuration on the first principal surface 2a side. FIG. 10 is a transparent view of the vibrating element 100 as seen from the first principal surface 2a side for explanation of the configuration on a second principal surface 2b side.

As below, in the vibrating element 100 according to the second embodiment, the same signs are assigned to the members having the same functions as those of the component elements of the above described vibrating element 100 according to the first embodiment, and their detailed explanation will be omitted.

In the above described vibrating element 100 according to the first embodiment, as shown in FIG. 2, the vibrating reed 1 is an H-shaped vibrating reed. On the other hand, in the vibrating element 100 according to the second embodiment, as shown in FIGS. 9 and 10, a vibrating reed 1 is the so-called double-T-shaped vibrating reed.

As shown in FIGS. 9 and 10, the vibrating reed 1 has a base part 10, connecting arms 210, 212, drive vibrating arms 220, 222, 224, 226, detection vibrating arms 230, 232, support parts 240, 242, beam parts 250, 252, 254, 256, drive input electrodes 30, drive output electrodes 32, first detection electrodes 40, second detection electrodes 42, third detection electrodes 44, fourth detection electrodes 46, drive input lines 50, drive output lines 52, first detection lines 60, second detection lines 62, third detection lines 64, and fourth detection lines 66.

The base part 10, the connecting arms 210, 212, the drive vibrating arms 220, 222, 224, 226, the detection vibrating arms 230, 232, the support parts 240, 242, and the beam parts 250, 252, 254, 256 form the vibrating reed 1.

The base part 10 has a center point G. The position of the center point G is the position of the center of gravity of the vibrating reed 1. The planar shape of the base part 10 is e.g., a rectangular shape (nearly rectangular shape).

The first connecting arm 210 and the second connecting arm 212 extend from the base part 10 in opposite directions to each other along the X-axis. In the illustrated example, the first connecting arm 210 extends from the base part 10 in the −X-axis direction and the second connecting arm 212 extends from the base part 10 in the +X-axis direction.

The first drive vibrating arm 220 and the second drive vibrating arm 222 extend from the first connecting arm 210 in opposite directions to each other along the Y-axis. In the illustrated example, the first drive vibrating arm 220 extends from the first connecting arm 210 in the +Y-axis direction and the second drive vibrating arm 222 extends from the first connecting arm 210 in the −Y-axis direction. The drive vibrating arms 220, 222 are connected to the base part 10 via the first connecting arm 210.

The third drive vibrating arm 224 and the fourth drive vibrating arm 226 extend from the second connecting arm 212 in opposite directions to each other along the Y-axis. In the illustrated example, the third drive vibrating arm 224 extends from the second connecting arm 212 in the +Y-axis direction and the fourth drive vibrating arm 226 extends from the second connecting arm 212 in the −Y-axis direction. The drive vibrating arms 224, 226 are connected to the base part 10 via the second connecting arm 212.

The first detection vibrating arm. 230 and the second detection vibrating arm 232 extend from the base part 10 in opposite directions to each other along the Y-axis. In the illustrated example, the first detection vibrating arm 230 extends from the base part 10 in the +Y-axis direction and the second detection vibrating arm 232 extends from the base part 10 in the −Y-axis direction. The detection vibrating arms 230, 232 are connected to the base part 10.

Wider parts 5 are provided on ends of the vibrating arms 220, 222, 224, 226, 230, 232. The wider parts 5 have larger widths (sizes in the X-axis directions) than the other parts of the vibrating arms 220, 222, 224, 226, 230, 232. Though not illustrated, weight parts may be provided in the wider parts 5. By adjustment of the masses of the weight parts, the frequencies of the vibrations of the vibrating arms 220, 222, 224, 226, 230, 232 may be adjusted.

The first support part 240 is provided nearer the side in the +Y-axis direction than the vibrating arms 220, 224, 230. The second support part 242 is provided nearer the side in the −Y-axis direction than the vibrating arms 222, 226, 232. The support parts 240, 242 are parts fixed to a package when the vibrating element 100 is mounted. The support parts 240, 242 support the base part 10 via the beam parts 250, 252, 254, 256.

The first beam part 250 and the second beam part 252 connect the base part 10 and the first support part 240. In the illustrated example, the first beam part 250 extends from the base part 10 through between the first drive vibrating arm 220 and the first detection vibrating arm 230 to the first support part 240. The second beam part 252 extends from the base part 10 through between the third drive vibrating arm 224 and the first detection vibrating arm 230 to the first support part 240.

The third beam part 254 and the fourth beam part 256 connect the base part 10 and the second support part 242. In the illustrated example, the third beam part 254 extends from the base part 10 through between the second drive vibrating arm 222 and the second detection vibrating arm 232 to the second support part 242. The fourth beam part 256 extends from the base part 10 through between the fourth drive vibrating arm 226 and the second detection vibrating arm 232 to the second support part 242.

The beam parts 250, 252, 254, 256 have nearly S-shaped parts in the plan view. Accordingly, the beam parts 250, 252, 254, 256 may have higher elasticity. Thereby, the support parts 240, 242 may support the base part 10 via the beam parts 250, 252, 254, 256 without hindering the vibrations of the vibrating arms 220, 222, 224, 226, 230, 232.

The drive input electrodes 30 are provided on the drive vibrating arms 220, 222, 224, 226. In the illustrated example, the drive input electrodes 30 are provided on the side surfaces 3 and the wider part 5 of the first drive vibrating arm 220, the side surfaces 3 and the wider part 5 of the second drive vibrating arm 222, the principal surfaces (principal surfaces except the wider part 5) 2a, 2b of the third drive vibrating arm 224, and the principal surfaces (principal surfaces except the wider part 5) 2a, 2b of the fourth drive vibrating arm 226. For example, the drive input electrodes 30 are provided plane-symmetrically with respect to the surface passing through the center point G in parallel to the XZ plane. The drive input electrodes 30 are electrodes to which signals (drive signals) for driving the drive vibrating arms 220, 222, 224, 226 are input.

The drive input electrodes 32 are provided on the drive vibrating arms 220, 222, 224, 226. In the illustrated example, the drive input electrodes 32 are provided on the principal surfaces (principal surfaces except the wider part 5) 2a, 2b of the first drive vibrating arm 220, the principal surfaces (principal surfaces except the wider part 5) 2a, 2b of the second drive vibrating arm 222, the side surfaces 3 and the wider part 5 of the third drive vibrating arm 224, and the side surfaces 3 and the wider part 5 of the fourth drive vibrating arm 226. For example, the drive input electrodes 32 are provided plane-symmetrically with respect to the surface passing through the center point G in parallel to the XZ plane. The drive output electrodes 32 are electrodes from which signals based on bending of the drive vibrating arms 220, 222, 224, 226 are output.

Note that, though not illustrated, the drive output electrodes 32 may be provided in the positions where the drive input electrodes 30 are provided, and the drive input electrodes 30 may be provided in the positions where the drive output electrodes 32 are provided.

The first detection electrodes 40 are provided on the first detection vibrating arm 230. In the illustrated example, the first detection electrodes 40 are provided on the principal surfaces (principal surfaces except the wider part 5) 2a, 2b of the first detection vibrating arm 230. The first detection electrodes 40 are electrodes for detecting signals (first detection signals) based on bending of the first detection vibrating arm 230 by Coriolis force.

The second detection electrodes 42 are provided on the first detection vibrating arm 230. In the illustrated example, the second detection electrodes 42 are provided on the side surfaces 3 and the wider part 5 of the first detection vibrating arm 230. The second detection electrodes 42 are electrodes for detecting signals (first detection signals) based on bending of the first detection vibrating arm 230 by Coriolis force. The second detection electrodes 42 are e.g., electrodes having a potential as reference for the first detection signals.

The third detection electrodes 44 are provided on the second detection vibrating arm 232. In the illustrated example, the third detection electrodes 44 are provided on the principal surfaces (principal surfaces except the wider part 5) 2a, 2b of the second detection vibrating arm 232. For example, the third detection electrodes 44 are provided plane-symmetrically to the first detection electrodes 40 with respect to the surface passing through the center point G in parallel to the XZ plane. The third detection electrodes 44 are electrodes for detecting signals (second detection signals) based on bending of the second detection vibrating arm 232 by Coriolis force.

The fourth detection electrodes 46 are provided on the second detection vibrating arm 232. In the illustrated example, the fourth detection electrodes 46 are provided on the side surfaces 3 and the wider part 5 of the second detection vibrating arm 232. For example, the fourth detection electrodes 46 are provided plane-symmetrically to the second detection electrodes 42 with respect to the surface passing through the center point G in parallel to the XZ plane. The fourth detection electrodes 46 are electrodes for detecting signals (second detection signals) based on bending of the second detection vibrating arm 232 by Coriolis force. The fourth detection electrodes 46 are e.g., electrodes having a potential as reference for the second detection signals.

Note that, though not illustrated, groove portions may be provided on the principal surfaces 2a, 2b of the vibrating arms 220, 222, 224, 226, 230, 232, and the electrodes 30, 32, 40, 44 may be provided within the groove portions.

The drive input lines 50 are provided on the base part 10, the connecting arms 210, 212, the second support part 242, and the third beam part 254. In the illustrated example, the drive input lines 50 are provided on the first principal surface 2a and the side surfaces 3 of the base part 10, the first principal surface 2a of the first connecting arm 210, the principal surfaces 2a, 2b and the side surface 3 of the second connecting arm 212, the principal surfaces 2a, 2b and the side surface 3 of the second support part 242, and the side surfaces 3 of the third beam part 254. By the drive input lines 50, the drive input electrodes 30 provided on the vibrating arms 220, 222, 224, 226 are electrically connected to one another. The drive input line 50 provided on the second support part 242 is a terminal portion 50a. In the illustrated example, the planar shape of the terminal portion 50a is a rectangular shape. The terminal portion 50a is connected to an external member (e.g., bonding wire), and the drive signals output from the drive circuit 440 are input to the drive input electrodes 30 via the external member and the drive input lines 50.

The drive output lines 52 are provided on the base part 10, the connecting arms 210, 212, the first support part 240, and the first beam part 250. In the illustrated example, the drive output lines 52 are provided on the second principal surface 2b of the base part 10, the principal surfaces 2a, 2b and the side surface 3 of the first connecting arm 210, the second principal surface 2b and the side surfaces 3 of the second connecting arm 212, the principal surfaces 2a, 2b and the side surface 3 of the first support part 240, and the second principal surface 2b and the side surfaces 3 of the first beam part 250. By the drive output lines 52, the drive output electrodes 32 provided on the vibrating arms 220, 222, 224, 226 are electrically connected to one another. The drive output line 52 provided on the first support part 240 is a terminal portion 52a. In the illustrated example, the planar shape of the terminal portion 52a is a rectangular shape. The terminal portion 52a is connected to an external member (e.g., bonding wire), and the signals output from the drive output electrodes 32 are input to the drive circuit 440 via the drive output lines 52 and the external member.

The first detection lines 60 are provided on the base part 10, the first support part 240, and the second beam part 252. In the illustrated example, the first detection lines 60 are provided on the principal surfaces 2a, 2b of the base part 10, the principal surfaces 2a, 2b and the side surfaces 3 of the first support part 240, and the first principal surface 2a and the side surfaces 3 of the second beam part 252. The first detection lines 60 are connected to the first detection electrodes 40. The first detection line 60 provided on the first support part 240 is a terminal portion 60a. In the illustrated example, the planar shape of the terminal portion 60a is a rectangular shape. The terminal portion 60a is connected to an external member (e.g., bonding wire), and the first detection signals output from the first detection electrodes 40 are input to the charge amplifier 451 of the detection circuit 450 via the first detection lines 60 and the external member.

The second detection lines 62 are provided on the base part 10, the first support part 240, and the second beam part 252. In the illustrated example, the second detection lines 62 are provided on the principal surfaces 2a, 2b and the side surfaces 3 of the base part 10, the principal surfaces 2a, 2b and the side surfaces 3 of the first support part 240, and the principal surfaces 2a, 2b and the side surfaces 3 of the second beam part 252. The second detection lines 62 are connected to the second detection electrodes 42. The second detection line 62 provided on the first support part 240 is a terminal portion 62a. In the illustrated example, the planar shape of the terminal portion 62a is a rectangular shape. The terminal portion 62a is connected to an external member (e.g., bonding wire), and a fixed potential, specifically, the ground potential is input to the second detection electrodes 42 via the second detection lines 62 and the external member.

The third detection lines 64 are provided on the base part 10, the second support part 242, and the fourth beam part 256. In the illustrated example, the third detection lines 64 are provided on the principal surfaces 2a, 2b of the base part 10, the principal surfaces 2a, 2b and the side surfaces 3 of the second support part 242, and the first principal surface 2a and the side surfaces 3 of the fourth beam part 256. The third detection lines 64 are connected to the third detection electrodes 44. The third detection line 64 provided on the second support part 242 is a terminal portion 64a. In the illustrated example, the planar shape of the terminal portion 64a is a rectangular shape. The terminal portion 64a is connected to an external member (e.g., bonding wire), and the second detection signals output from the third detection electrodes 44 are input to the charge amplifier 452 of the detection circuit 450 via the third detection lines 64 and the external member.

The fourth detection lines 66 are provided on the base part 10, the second support part 242, and the fourth beam part 256. In the illustrated example, the fourth detection lines 66 are provided on the principal surfaces 2a, 2b and the side surfaces 3 of the base part 10, the principal surfaces 2a, 2b and the side surfaces 3 of the second support part 242, and the principal surfaces 2a, 2b and the side surfaces 3 of the fourth beam part 256. The fourth detection lines 66 are connected to the fourth detection electrodes 46. The fourth detection line 66 provided on the second support part 242 is a terminal portion 66a. In the illustrated example, the planar shape of the terminal portion 66a is a rectangular shape. The terminal portion 66a is connected to an external member (e.g., bonding wire), and a fixed potential, specifically, the ground potential is input to the fourth detection electrodes 46 via the fourth detection lines 66 and the external member.

Note that, in FIGS. 9 and 10, the electrodes 30, 32, 40, 42, 44, 46 and the lines 50, 52, 60, 62, 64, 66 provided on the side surfaces 3 of the vibrating reed 1 are shown by thick lines.

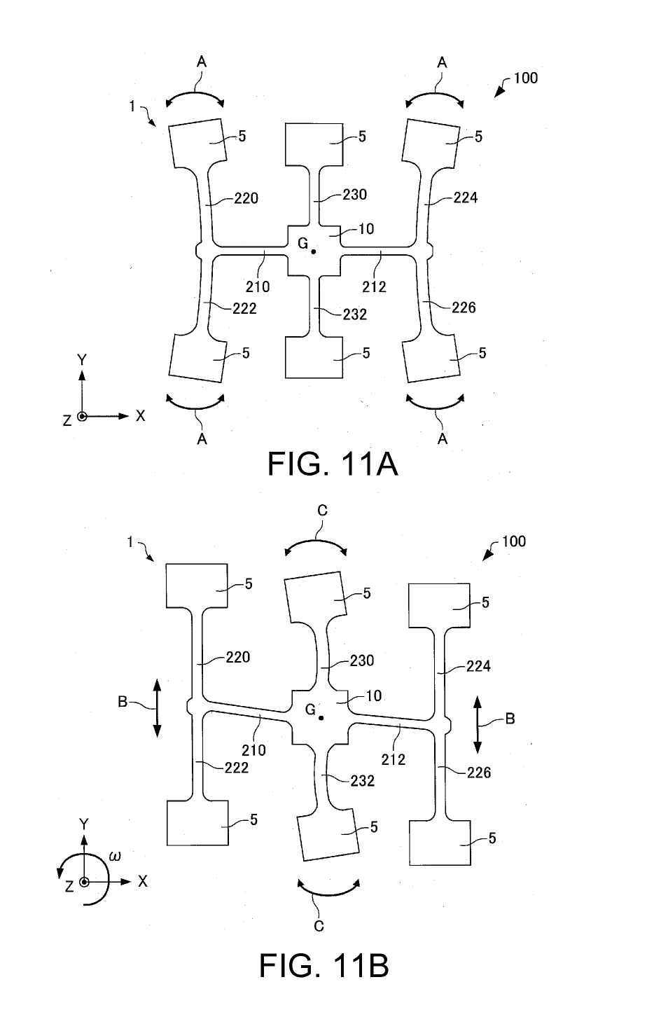

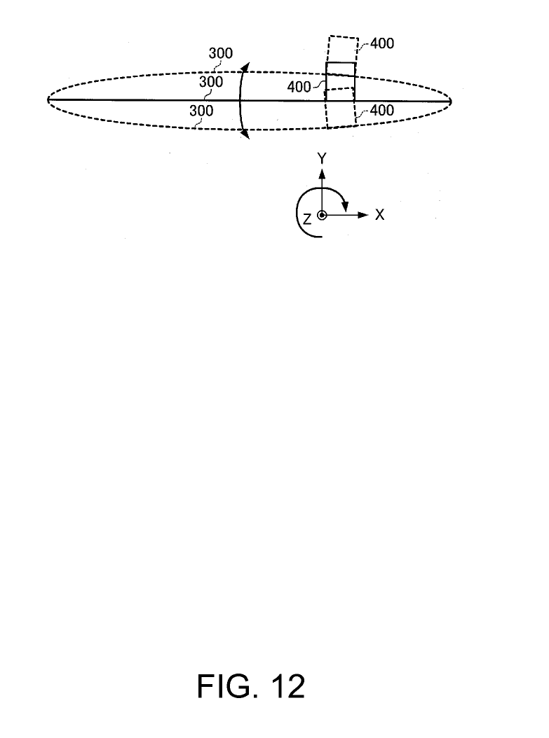

Next, movements of the vibrating element 100 will be explained. FIGS. 11A and 11B are plan views for explanation of the movements of the vibrating element 100. Note that, for convenience, illustration of the other members than the base part 10, the connecting arms 210, 212, and the vibrating arms 220, 222, 224, 226, 230, 232 is omitted in FIGS. 11A and 11B.

As shown in FIG. 11A, under a condition that no angular velocity is applied to the vibrating element 100, when a predetermined alternating-current voltage is applied to the drive input electrodes 30 provided on the drive vibrating arms 220, 222, 224, 226, the vibrating element 100 perform bending movements in directions of arrows A within the XY plane (drive mode). In this regard, the drive vibrating arms 220, 222 and the drive vibrating arms 224, 226 perform vibrations plane-symmetrical with respect to the plane passing through the center point G in parallel to the YZ plane. Accordingly, the base part 10, the connecting arms 210, 212, and the detection vibrating arms 230, 232 hardly vibrate.

Under the condition that the drive vibrating arms 220, 222, 224, 226 are driven to vibrate, when an angular velocity ω about the Z-axis is applied to the vibrating element 100 as shown in FIG. 11B, Coriolis force acts on the drive vibrating arms 220, 222, 224, 226. Thereby, the drive vibrating arms 220, 222, 224, 226 vibrate in directions of arrows B. The vibrations in the directions of the arrows B are circumferential vibrations with respect to the center point G. According to the vibrations of the drive vibrating arms 220, 222, 224, 226, the connecting arms 210, 212 vibrate in the direction of the arrow B. The vibrations are transmitted to the detection vibrating arms 230, 232 via the base part 10 and vibrate the detection vibrating arms 230, 232 as shown by arrows C (detection mode). The vibrations in the directions of the arrows C are vibrations in the circumferentially opposite directions to the arrows B with respect to the center point G. By the bending vibrations of the detection vibrating arms 230, 232, the first detection signals and the second detection signals are generated in the first detection electrodes 40 and the third detection electrodes 44, respectively.

In this regard, the electric polarity of the first detection signals and the electric polarity of the second detection signals are opposite. For example, when positive charge δ+ is generated in the first detection electrodes 40, negative charge δ− is generated in the third detection electrodes 44, and, when negative charge δ− is generated in the first detection electrodes 40, positive charge δ+ is generated in the third detection electrodes 44. The first detection signals are output from the terminal portion 60a to the detection circuit 450 and the second detection signals are output from the terminal portion 64a to the detection circuit 450, and the detection circuit 450 may obtain the angular velocity about the Z-axis using these detection signals.

In the physical quantity detecting device 400 according to the embodiment, the Z-axis perpendicular to the principal surfaces 2a, 2b of the vibrating element 100 is the detection axis, and, even when the element is mounted with the principal surfaces 2a, 2b in parallel to the mounting board 300 as shown in FIG. 6, the detection axis is not aligned with the vibration direction of the mounting board 300 and there is little possibility that the output signals of the detection circuit 450 may be saturated. However, when the element is mounted with the principal surfaces 2a, 2b perpendicular to the mounting board 300 as shown in FIG. 12, the detection axis is easily aligned with the vibration direction of the mounting board 300 and there is a possibility that the output signals of the detection circuit 450 may be saturated.

However, also, in the physical quantity detecting device 400 according to the embodiment, the same filter circuit 454 as that of the first embodiment is provided at the upstream of the AC amplifier circuit 455, and thereby, even when the mounting board 300 rotationally vibrates at the frequency close to the detuning frequency Δf, the signals at the frequency components close to the frequency f_{dt} are removed by the filter circuit 454. Thereby, the possibility of saturation of the output signals of the detection circuit 450 is reduced. Therefore, variations of the center voltage (zero-point voltage) in the output signals of the detection circuit 450 are suppressed, and thereby, the strong physical quantity detecting device 400 with higher detection accuracy, robustness to vibrations and impacts, and the higher degree of freedom of the mounting position may be realized.

### 1-3. Third Embodiment

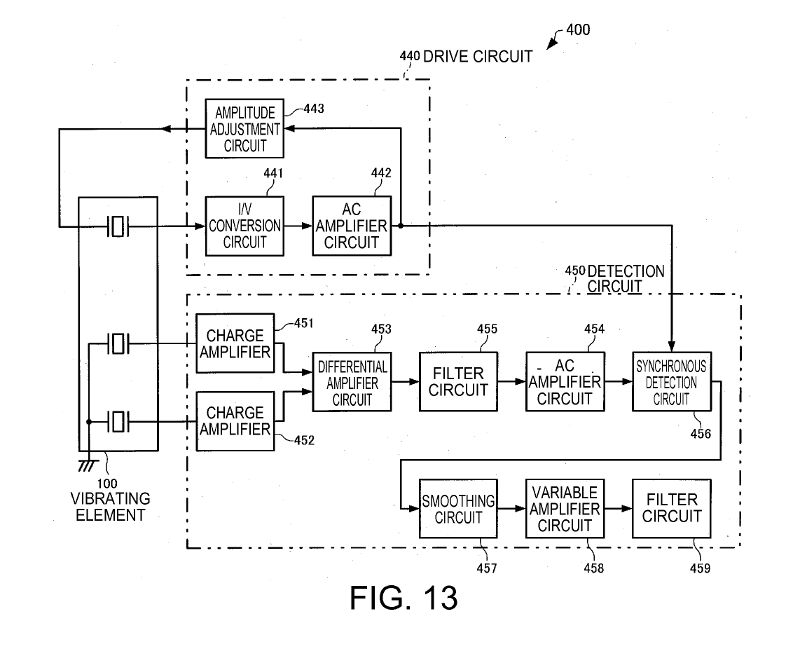

FIG. 13 is a functional block diagram of a physical quantity detecting device 400 according to the third embodiment. In FIG. 13, the same signs are assigned to the same component elements as those in FIG. 1. As shown in FIG. 13, in the physical quantity detecting device 400 according to the third embodiment, the output signals of the differential amplifier circuit 453 are input to the AC amplifier circuit 455 and the signals AC-amplified in the AC amplifier circuit 455 are input to the filter circuit 454.

Like the first embodiment, the filter circuit 454 functions as a filter part having the cutoff frequency f_{c} between the resonance frequency f_{dr} in the drive mode and the resonance frequency f_{dt} in the detection mode of the vibrating element 100 and containing the resonance frequency f_{dr} in the drive mode in the passband. The filter circuit 454 is formed as a low-pass filter when the vibrating element 100 has the relationship of f_{dr}<f_{dt} and formed as a high-pass filter when the vibrating element 100 has the relationship of f_{dr}>f_{dt}. The output signals of the filter circuit 454 are input to the synchronous detection circuit 456.

The rest of the configuration of the physical quantity detecting device 400 according to the third embodiment is the same as the physical quantity detecting device 400 according to the first embodiment or the second embodiment, and the explanation will be omitted.

According to the physical quantity detecting device 400 of the third embodiment, like the physical quantity detecting device 400 according to the first embodiment or the second embodiment, the filter circuit 454 is provided at the upstream of the AC amplifier circuit 455, and thereby, even when the rotational vibration at the frequency close to the detuning frequency Δf of the vibrating element 100 is applied, the possibility of saturation of the output signals of the detection circuit 450 may be reduced. Therefore, variations of the center voltage (zero-point voltage) in the output signals of the detection circuit 450 are suppressed, and thereby, the strong physical quantity detecting device 400 with higher detection accuracy, robustness to vibrations and impacts, and the higher degree of freedom of the mounting position may be realized.

Particularly, the filter circuit 454 is provided at the upstream of the synchronous detection circuit 456, and thereby, the possibility of saturation of the output signals of the synchronous detection circuit 456 may be reduced, and the configuration is advantageous compared to the case where the signals at the frequency f₁ by the rotational vibration are removed by the smoothing circuit 457.

### 1-4. Fourth Embodiment

A physical quantity detecting device 400 according to the fourth embodiment is different from the physical quantity detecting devices according to the first embodiment to the third embodiment in that the filter circuit 454 is formed as a bandpass filter. The functional block diagram of the physical quantity detecting device according to the fourth embodiment is the same as FIG. 1 or FIG. 13 and the illustration and explanation will be omitted.

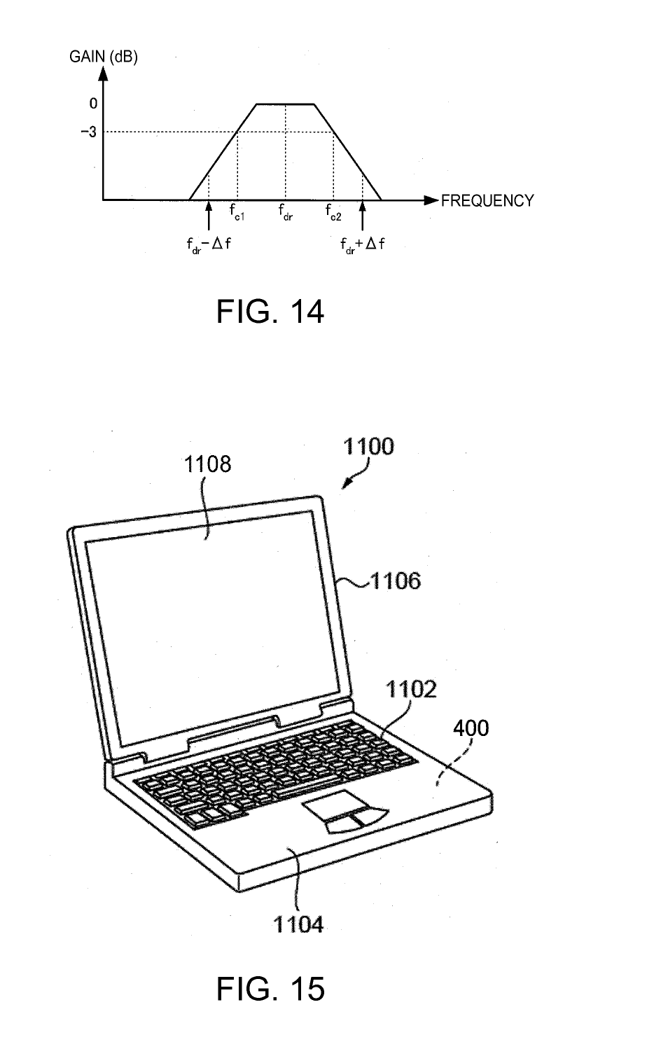

FIG. 14 shows an example of filter characteristics of a filter circuit 454 according to the fourth embodiment. As shown in FIG. 14, the filter circuit 454 is formed so that f_{dr} may be contained in the passband and a cutoff frequency f_{cl} at the lower frequency side may be larger than the difference f_{dr}−Δf between the resonance frequency f_{dr} in the drive mode and the detuning frequency Δf and a cutoff frequency f_{c2} at the higher frequency side may be smaller than the sum f_{dr}+Δf of the resonance frequency f_{dr} in the drive mode and the detuning frequency Δf. According to the configuration, when the rotational vibration at the frequency f₁ close to the detuning frequency Δf is applied, both the signal at the frequency component f_{dr}−f₁ and the signal at the frequency component f_{dr}+f₁ contained in the detection signals of the vibrating element 100 are removed by the filter circuit 454, and these signals are not synchronously detected in the synchronous detection circuit 456.

Therefore, according to the physical quantity detecting device 400 of the fourth embodiment, compared to the physical quantity detecting devices 400 according to the first embodiment to the third embodiment, the possibility of saturation of the output signals of the synchronous detection circuit 456 may be further reduced.

### 2. Electronic Apparatuses

Next, electronic apparatuses according to the embodiment will be explained with reference to the drawings. The electronic apparatuses according to the embodiment include the physical quantity detecting devices according to the invention. As below, the electronic apparatuses including the physical quantity detecting device 400 as the physical quantity detecting device according to the invention will be explained.

FIG. 15 is a perspective view schematically showing a mobile (or notebook) personal computer 1100 as the electronic apparatus according to the embodiment.

As shown in FIG. 15, the personal computer 1100 includes a main body unit 1104 having a keyboard 1102 and a display unit 1106 having a display part 1108, and the display unit 1106 is rotatably supported via a hinge structure part with respect to the main body unit 1104.

The personal computer 1100 contains the physical quantity detecting device 400.

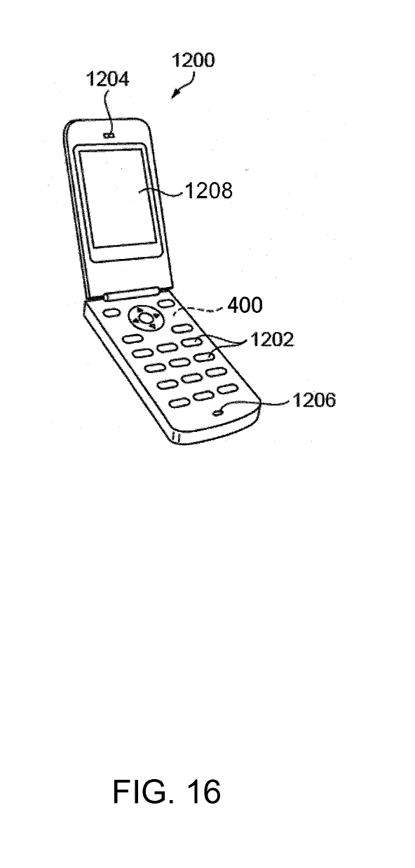

FIG. 16 is a perspective view schematically showing a cell phone (including a PHS) 1200 as the electronic apparatus according to the embodiment.

As shown in FIG. 16, the cell phone 1200 includes a plurality of operation buttons 1202, an ear piece 1204, and a mouthpiece 1206, and a display part 1208 is provided between the operation buttons 1202 and the ear piece 1204.

The cell phone 1200 contains the physical quantity detecting device 400.

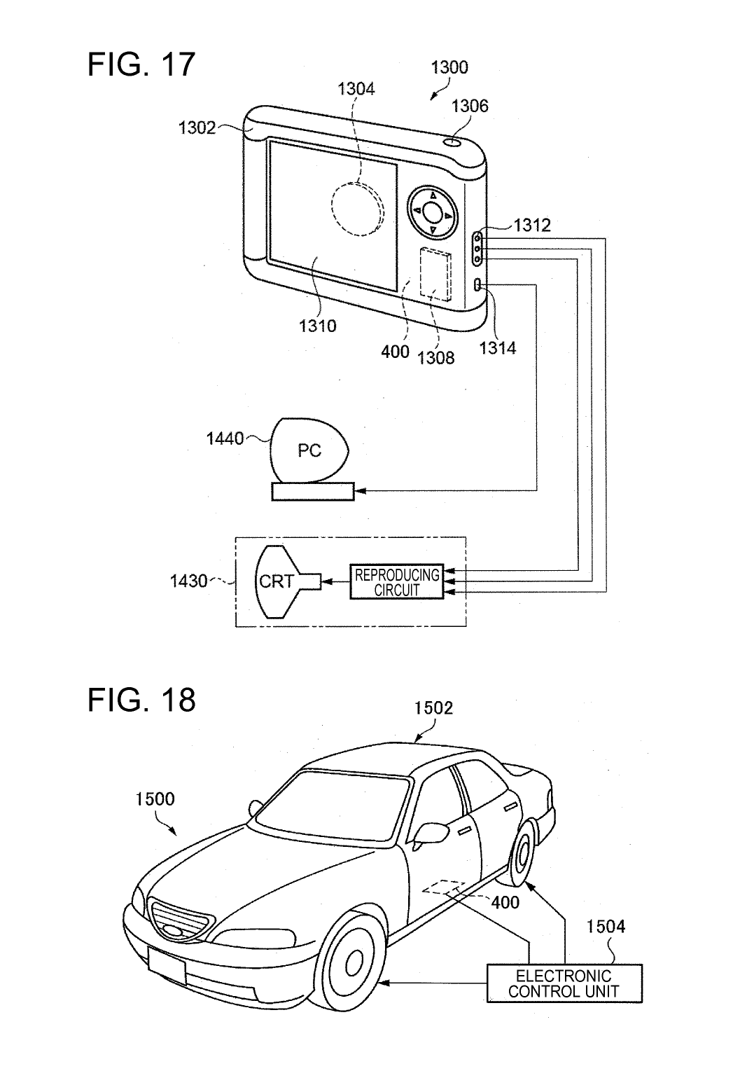

FIG. 17 is a perspective view schematically showing a digital still camera 1300 as the electronic apparatus according to the embodiment. Note that, in FIG. 17, connection to an external device is simply shown.

Here, in an ordinary camera, a silver halide photographic film is exposed to light by an optical image of a subject and, on the other hand, the digital still camera 1300 photoelectrically converts an optical image of a subject using an image sensing device such as a CCD (Charge Coupled Device) and generates imaging signals (image signals).

On a back surface of a case (body) 1302 in the digital still camera 1300, a display part 1310 is provided and adapted to display based on the imaging signals by the CCD, and the display part 1310 functions as a finder that displays the subject as an electronic image.

Further, on the front side (the rear side in the drawing) of the case 1302, a light receiving unit 1304 including an optical lens (imaging system), the CCD, etc. is provided.

When a photographer checks the subject image displayed on the display part 1310 and presses down a shutter button 1306, the imaging signals of the CCD at the time are transferred and stored into a memory 1308.

Further, in the digital still camera 1300, a video signal output terminal 1312 and an input/output terminal for data communication 1314 are provided on the side surface of the case 1302. Furthermore, a television monitor 1430 is connected to the video signal output terminal 1312 and a personal computer 1440 is connected to the input/output terminal for data communication 1314, respectively, as appropriate. In addition, by predetermined operation, the imaging signals stored in the memory 1308 are output to the television monitor 1430 and the personal computer 1440.

The digital still camera 1300 contains the physical quantity detecting device 400.

Note that the electronic apparatus including the physical quantity detecting device 400 may be applied not only to the personal computer (mobile personal computer) shown in FIG. 15, the cell phone shown in FIG. 16, and the digital still camera shown in FIG. 17 but also to e.g., inkjet ejection devices (e.g., inkjet printers), laptop personal computers, televisions, video cameras, video tape recorders, various navigation systems, pagers, personal digital assistances (with or without communication function), electronic dictionaries, calculators, electronic game machines, head mounted displays, word processors, work stations, videophones, security television monitors, electronic binoculars, POS terminals, medical apparatuses (e.g., electronic thermometers, sphygmomanometers, blood glucose meters, electrocardiographic measurement systems, ultrasonic diagnostic systems, or electronic endoscopes), fish finders, various measurement instruments, meters and gauges (e.g., meters for vehicles, airplanes, rockets, and ships), attitude control for robots and human bodies, and flight simulators.

The electronic apparatus according to the embodiment contains the physical quantity detecting device 400 with higher detection accuracy. Therefore, the electronic apparatus according to the embodiment may have better properties.

### 3. Moving object

Next, a moving object according to the embodiment will be explained with reference to the drawings. The moving object according to the embodiment includes the physical quantity detecting device according to the invention. As below, the moving object including the physical quantity detecting device 400 as the physical quantity detecting device according to the invention will be explained.

FIG. 18 is a perspective view schematically showing an automobile 1500 as the moving object according to the embodiment.

The automobile 1500 contains the physical quantity detecting device 400. Specifically, as shown in FIG. 18, an electronic control unit (ECU) 1504 that contains the vibrating element 100 for sensing the angular velocity of the automobile 1500 and controls output of an engine is mounted on a vehicle body 1502 of the automobile 1500. In addition, the physical quantity detecting device 400 may be widely applied to a vehicle body attitude control unit, an antilock brake system (ABS), an airbag, and a tire pressure monitoring system (TPMS).

The moving object according to the embodiment contains the physical quantity detecting device 400 with higher detection accuracy. Therefore, the moving object according to the embodiment may have better properties.

The invention is not limited to the embodiments, but various modifications may be made within the scope of the invention.

For example, the vibrating reed 1 of the vibrating element 100 may have not only the H shape or double-T shape but also e.g., a tuning-fork shape or comb-teeth shape, a tuning-bar shape in a triangular prism, quadrangular prism, column, or the like, or a three-armed shape.

Further, as the material of the vibrating reed 1, not only the piezoelectric material of piezoelectric single crystal such as quartz crystal (SiO₂), lithium tantalate (LiTaO₃), or lithium niobate (LiNbO₃) but also a piezoelectric material such as piezoelectric ceramics of lead zirconate titanate (PZT).

For example, the vibrating element 100 may have a structure in which the vibrating reed 1 is formed using silicon semiconductor, a piezoelectric thin film of zinc oxide (ZnO), aluminum nitride (AlN), or the like sandwiched between electrodes is provided in a part of the surface of the vibrating reed 1 (silicon semiconductor).

Further, the vibrating element 100 may be not only the piezoelectric vibrating element but also an electrodynamic, capacitance (silicon MEMS or the like), eddy-current, optical, strain-gauge vibrating element.

Furthermore, the physical quantity detected by the vibrating element 100 is not limited to the angular velocity, but may be angular acceleration, acceleration, velocity, force, or the like. That is, the detection circuit 450 or the physical quantity detecting device 400 may output signals in response not only to the angular velocity but also to the magnitude of angular acceleration, acceleration, velocity, force, or the like.

The above described embodiments and modified examples are just examples, and the invention is not limited to those. For example, the respective embodiments and the respective modified examples may be appropriately combined.

The invention includes substantially the same configurations (for example, the same configurations in function, method, and result or the same configurations in purpose and advantage) as the configurations explained in the embodiments. Further, the invention includes configurations in which non-essential parts of the configurations explained in the embodiments are replaced. Furthermore, the invention includes configurations that may exert the same effects or achieve the same purposes as those of the configurations explained in the embodiments. In addition, the invention includes configurations formed by adding known technologies to the configurations explained in the embodiments.

The entire disclosure of Japanese Patent Application No. 2014-061547, filed Mar. 25, 2014 is expressly incorporated by reference herein.

What is claimed is:

1. A physical quantity detection circuit comprising:
a filter part having a cutoff frequency between a resonance frequency in a drive mode and a resonance frequency in a detection mode of a vibrating element and containing the resonance frequency in the drive mode in a passband; and
a detection part that is provided at a downstream of the filter part and detects a signal in response to a physical quantity contained in an output signal of the vibrating element based on a drive signal for driving the vibrating element.

2. The physical quantity detection circuit according to claim 1, wherein the resonance frequency in the drive mode is lower than the resonance frequency in the detection mode, and
the filter part has the cutoff frequency lower than the resonance frequency in the detection mode.

3. The physical quantity detection circuit according to claim 1, wherein the resonance frequency in the drive mode is higher than the resonance frequency in the detection mode, and
the filter part has the cutoff frequency higher than the resonance frequency in the detection mode.

4. The physical quantity detection circuit according to claim 1, further comprising:
a differential amplification part that differentially amplifies the output signal of the vibrating element, the filter part provided at a downstream of the differential amplification part; and
an alternating-current amplification part provided at a downstream of the filter part, the detection part provided at a downstream of the alternating-current amplification part.

5. The physical quantity detection circuit according to claim 1, further comprising:
a differential amplification part that differentially amplifies the output signal of the vibrating element; and
an alternating-current amplification part provided at a downstream of the differential amplification part, the filter part provided at a downstream of the alternating-current amplification part.

6. A physical quantity detecting device comprising:
the physical quantity detection circuit according to claim 1; and
the vibrating element.

7. A physical quantity detecting device comprising:
the physical quantity detection circuit according to claim 2; and
the vibrating element.

8. A physical quantity detecting device comprising:
the physical quantity detection circuit according to claim 3; and
the vibrating element.

9. A physical quantity detecting device comprising:
the physical quantity detection circuit according to claim 4; and
the vibrating element.

10. An electronic apparatus comprising the physical quantity detection circuit according to claim 1.

11. An electronic apparatus comprising the physical quantity detection circuit according to claim 2.

12. An electronic apparatus comprising the physical quantity detection circuit according to claim 3.

13. An electronic apparatus comprising the physical quantity detection circuit according to claim 4.

14. An electronic apparatus comprising the physical quantity detecting device according to claim 6.

15. A moving object comprising the physical quantity detection circuit according to claim 1.

16. A moving object comprising the physical quantity detection circuit according to claim 2.

17. A moving object comprising the physical quantity detection circuit according to claim 3.

18. A moving object comprising the physical quantity detection circuit according to claim 4.

19. A moving object comprising the physical quantity detecting device according to claim 6.
